(19) United States
(12) Patent Application Publication
(10) Pub. No.: US 2012/0227698 A1
(43) Pub. Date: Sep. 13, 2012

(54) MULTILAYER GASKET WITH EXTENDED RIM LABYRINTH FEATURE

(76) Inventor: Bhawani Sankar Tripathy, Ann Arbor, MI (US)

(21) Appl. No.: 13/415,076

(22) Filed: Mar. 8, 2012

Related U.S. Application Data
(63) Continuation-in-part of application No. 13/030,179, filed on Feb. 18, 2011.
(60) Provisional application No. 61/306,093, filed on Feb. 19, 2010.

(51) Int. Cl. F02F 11/00; F02F 3/00

(52) U.S. Cl. 123/193.1; 277/591; 277/592

(57) ABSTRACT

A multilayer metal gasket having first and second functional layers. Each layer includes an opening for sealing a fluid passage or combustion chamber. Each layer includes a folded lip or rim bent in opposite directions and overlapping one another in a nested configuration to form a labyrinth which serves also as the compression stopper feature for the gasket assembly. Sealing beads are formed in each layer and, preferably, are arranged to contact each other in crest-to-crest orientation to perfect a seal. In one embodiment, the first rim is extended in length, and extends into and partially fills a crevice volume defined in the space between a piston and the side wall of a combustion chamber above the top piston ring.

### CROSS REFERENCE TO RELATED APPLICATIONS

This application is a Continuation-In-Part of U.S. Ser. No. 13/030,179 filed Feb. 18, 2011, which claims priority to Provisional Patent Application No. 61/306,093 filed Feb. 19, 2010, the entire disclosure of which is hereby incorporated by reference and relied upon.

### BACKGROUND OF THE INVENTION

1. Field of the Invention

This invention relates to multilayer gaskets, and more particularly to multilayer metal gaskets including a stopper for limiting compression height of the gasket when installed between two mating surfaces.

2. Related Art

Multilayer metal gaskets, also referred to by some as multilayer steel (MLS) gaskets, are commonly used in static sealing applications that require a fluid-tight seal to be created around a passage shared by two mating members. For example, an MLS gasket, generally indicated at 20 in FIG. 1, may be clamped between a cylinder head 22 and an engine block 24 to perfect a combustion seal around multiple combustion chambers as well as around oil and lubrication passages shared by the two mating members 22, 24. However, multilayer metal gaskets can also be used in other applications, such as to seal an exhaust manifold to an engine block, as well as other engine and non-engine applications. An enlarged fragmentary view of a prior art multilayer gasket 20 is shown in FIG. 2. Frequently, cylinder head gaskets 20 like that shown in FIGS. 1 and 2 include multiple bore openings to correspond with multiple cylinders in an engine block 24. The narrow region between adjacent openings is sometimes called a bridge portion 26. In traditional multilayer gasket applications, the bridge portion 26 can be a difficult area to seal. The constant transition between compression and expansion in adjacent cylinders creates substantial cyclic pressure differentials that are difficult to contain with a narrow strip of gasket 20. As a result, it is common for some combustion gases to leak through the multiple layers of the gasket 20, particularly in the bridge portion 26, resulting in some loss of engine efficiency.

Multilayer gaskets are particularly useful in applications which require a minimal thickness gasket capable of sealing effectively under fairly low and/or highly variable contact pressures. US Publication No. 2005/0189724, assigned to the assignee of this invention, the entire disclosure of which is hereby incorporated by reference, discloses a multilayer metal gasket including first and second functional layers formed with respective openings that coincide with a cylinder chamber. The functional layers include opposed sealing beads around the opening, together with an interposed stopper layer serving as a compression limiting feature to establish a final, i.e., fully compressed, assembled height.

One shortcoming in many prior art multilayer gasket designs may be attributed to the combustion gas leak paths which can easily form at the exposed edges of the stacked functional layers as they terminate around the opening for the combustion chamber or other flow passage shared between the mating surfaces. Combustion gases are typically held at bay by the compression stopper, sealing beads and other compacted layers of the gasket. However, as combustion pressures fluctuate and vibrations propagate, minor separations in the gasket layers may enable a momentary but recurring leak path for hot combustion gases, resulting in a decrease in engine efficiencies. Furthermore, the high cost of multilayer gaskets is always a concern; lower cost designs are sought after. For all of these reasons and others, there is a need in the art for new and improved multilayer gaskets that will overcome the shortcomings inherent in prior art designs and provide better sealing of combustion gases with minimal increase in cost and/or fabrication complexity.

### SUMMARY OF THE INVENTION

A multi-layered gasket assembly is provided of the type for sealing around a passage or chamber. The gasket assembly includes a first functional layer comprising a generally planar body having a thickness. The first layer has an included first opening. A second functional layer comprising a generally planar body has a thickness. The second layer also has an included second opening. The first layer overlies the second layer so that the respective first and second openings are generally aligned along a respective laterally extending axis. The first layer includes a first rim directly adjacent the first opening. The first rim extends laterally downwardly from the planar body of the first layer to a first terminal edge. The first rim has a first rim height measured axially at the first opening. The second layer includes a second rim directly adjacent the second opening. The second rim extends laterally upwardly from the planar body of the second layer to a second terminal edge. The second rim has a second rim height measured axially at the second opening. The first rim closely surrounds the second rim in nested overlapping relationship to form a labyrinth about the opening. The first rim height is greater than the sum of the second rim height plus the thickness of the first layer so that the first terminal edge extends below the planar body of the second layer.

The labyrinth stopper of this subject invention, formed by the nesting first and second rims, creates a tortuous path for combustion gases which resist the leakage of fluid, particularly between the gasket layers and even in conditions where vibration and cyclic pressure fluctuations may cause transient separations between the gasket layers. As a result, the gasket assembly of this invention improves performance of the gasket assembly. In certain applications, the extended length first rim may be advantageous to partially fill a crevice volume associated with the member to be sealed. Furthermore, the labyrinth stopper is simple to manufacture using known construction techniques and can, in preferred embodiments, be formed integrally from the base material used to manufacture the respective first and second functional layers. This, therefore, can be accomplished without welding or otherwise affixing separate stopper layers or by other complicated fabrication techniques.

According to another aspect of this invention, the above-described gasket assembly is combined with an internal combustion engine of the type including a block having a top deck surface. At least one combustion chamber is formed in the block. The combustion chamber is defined by a cylindrical side wall. A piston is disposed in the combustion chamber for reciprocating movement toward and away from a top dead center position. The piston includes a top piston ring that extends radially outwardly therefrom and directly engages the side wall of the combustion chamber. A crevice volume is defined in the space between the piston and the side wall above said top piston ring and below said deck surface. In this embodiment, the extended length first rim extends into and at least partially fills the crevice volume.

### BRIEF DESCRIPTION OF THE DRAWINGS

These and other features and advantages of the present invention will become more readily appreciated when considered in connection with the following detailed description and appended drawings, wherein:

FIG. 1 shows a prior art engine assembly partially exploded with multilayer gasket disposed between an engine block and cylinder head;

FIG. 2 is an enlarged, fragmentary view of a multilayer cylinder head gasket according to the prior art;

FIG. 3 is a fragmentary, cross-sectional view of a gasket assembly according to the subject invention including the novel labyrinth stopper feature;

FIGS. 4A-C show a progression of assembly for the first and second functional layers of a gasket manufactured according to one embodiment of this invention and highlighting the relative heights of the first and second rims;

FIG. 5 is an enlarged, perspective view as in FIG. 4C;

FIG. 6 is a fragmentary view of a gasket assembly according to this invention including a pair of side-by-side openings, with the second functional layer shown in partial cross-section through the bridge portion of the gasket;

FIG. 7 is an enlarged, cross-sectional view of the bridge portion of the subject gasket assembly and illustrating a tortuous gas leakage path created by the labyrinth stopper;

FIG. 8 is a cross-sectional view of an alternative embodiment of this invention including an intermediate shim layer disposed between the first and second layers;

FIG. 9 is a cross-sectional view showing another alternative embodiment of this invention including a supplemental member disposed between the labyrinth stopper and sealing bead of the second layer;

FIG. 10 is a view as in FIG. 9 showing an alternative placement for the optional supplemental member on the first layer;

FIG. 11 is a cross-sectional view showing a still further alternative embodiment of this invention wherein the first and second layers are provided with an optional elastomer coating and the sealing beads are arranged to face away from one another;

FIG. 12 is an alternative embodiment of the subject invention showing the second rim of the second layer having an undulating profile;

FIG. 13 is a cross-sectional view through a combustion chamber of an internal combustion engine including a piston disposed therein at a top dead center position and showing a second alternative embodiment of the subject gasket including an extended first rim adapted to at least partially fill the crevice volume above a top piston ring;

FIG. 14 is an enlarged view of the area circumscribed at 14 in FIG. 13;

FIG. 15 is a perspective view of an optional spring element;

FIG. 16 is a fragmentary cross-sectional view showing the spring element of FIG. 15 disposed for operation in a gasket assembly according to the second alternative embodiment like that of FIGS. 13 and 14; and

FIG. 17 is a cross-sectional view as in FIG. 16 but showing a pair of stacked spring elements to increase the dynamic response of the gasket assembly.

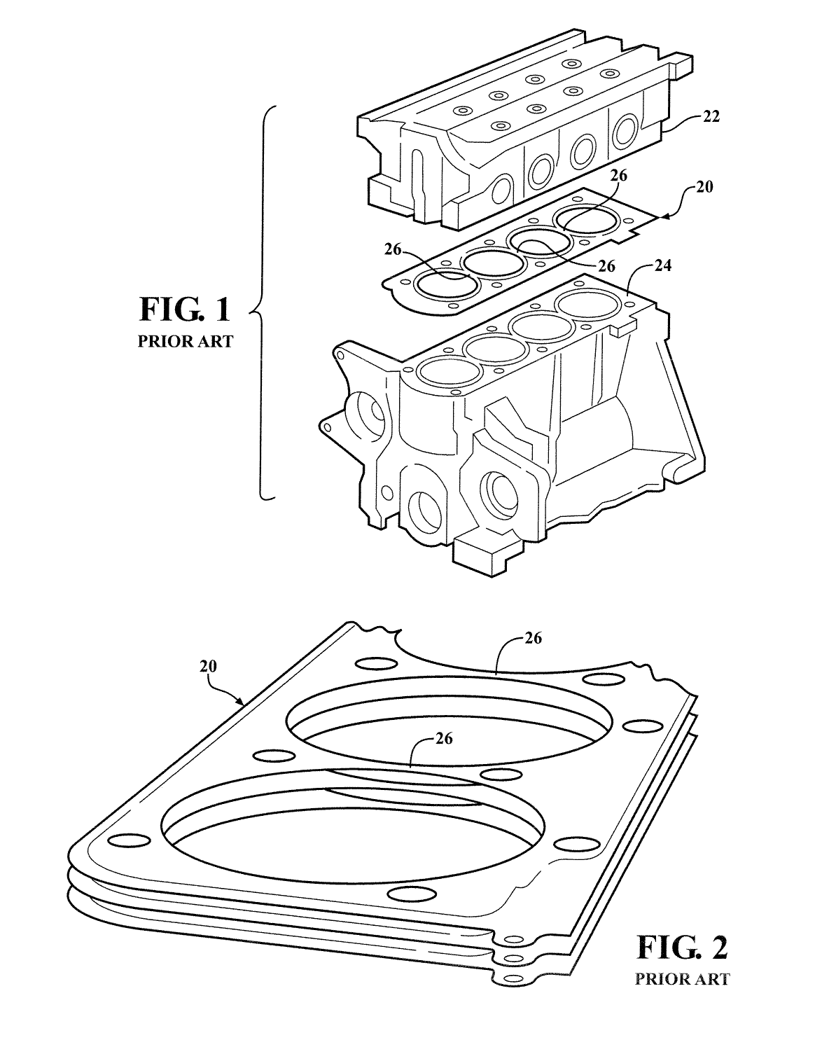

### DETAILED DESCRIPTION OF THE PREFERRED EMBODIMENT

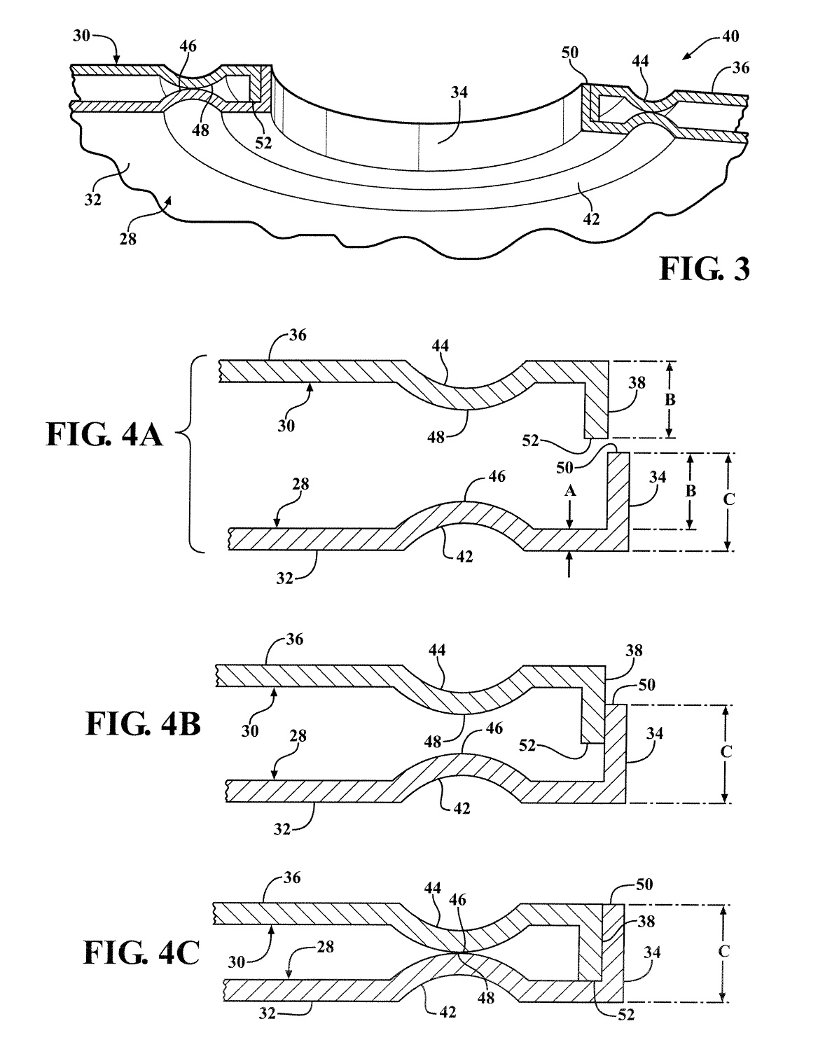

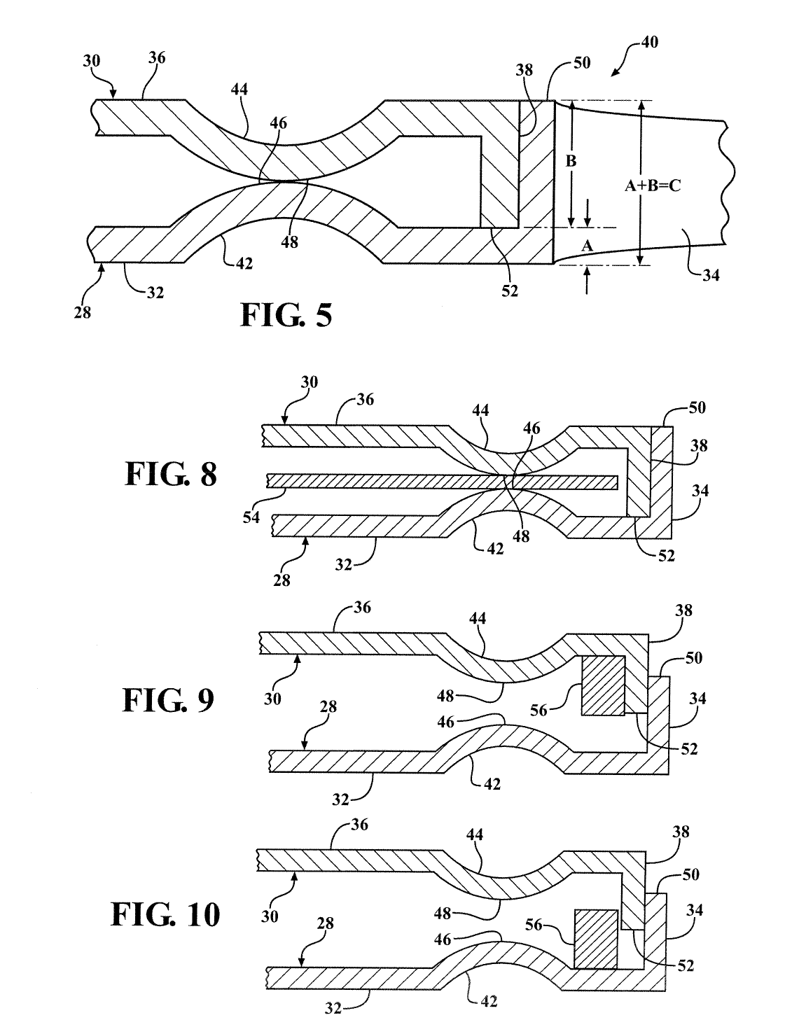

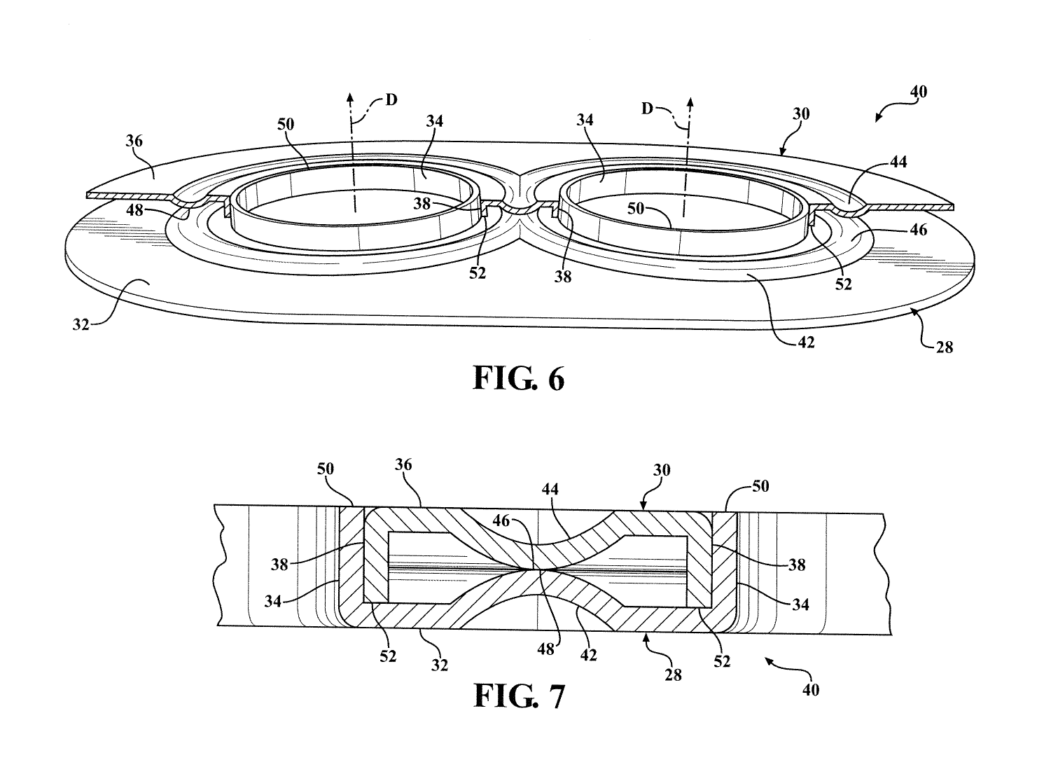

Referring to the figures wherein like numerals indicate like or corresponding parts throughout the several views, a multilayer gasket according to one embodiment of this invention is generally showing at 40 in FIGS. 3-10. The embodiment shown in FIGS. 3-7 includes a first functional layer, generally indicated at 28, and a second functional layer, generally indicated at 30. The first layer 28 comprises a generally planar body 32 having a generally uniform thickness A (see FIGS. 4A and 5). A first opening 34 is formed in the first layer 28 for sealing around a shared passage between the two mating members to be sealed, such as around a combustion opening between a cylinder head and a cylinder block. The second functional layer 30 may be similar in construction to the first layer 28 and also comprises a generally planar second body 36 and a second opening 38. Assembled together as a unit, the first 28 and second 30 layers form the gasket assembly. In the assembly 40, the first 28 and second 30 layers overlie one another such that the respective first 34 and second 38 openings are generally aligned. In cases where the openings 34, 38 can be defined relative to an axis, such as for circular or oval formations, the two layers 28, 30 may be said to be aligned along a laterally extending axis. In the example of a gasket assembly 40 used to seal a cylinder head in an engine, the axis D will coincide with the bore axis of the combustion chamber, as shown in FIG. 6.

The gasket assembly 40 includes at least one, but preferably at least two, sealing beads 42, 44 encircling the openings 34, 38. The sealing beads 42, 44 may be carried on intermediate or non-functions layers of the gasket assembly 40, but more preferably are disposed on the first 28 and second 30 layers. The sealing beads 42, 44 may be formed integrally or formed separately and attached as shown in the figures. Preferably both sealing beads 42, 44 oppose one another and work in concert to enhance the sealing functionality of the gasket assembly 40. In particular, the first layer 28 includes an integrally formed first sealing bead 42 spaced apart from the first opening 34, and the second layer 30 includes a second sealing beat 44 spaced apart from its second opening 38. In situations where the respective openings 34, 38 are circular, as is typical in cylinder head gasket applications for example, the sealing beads 42, 44 are also preferably circular although other geometries are certainly possible. When viewed in cross-section as in FIGS. 4A-C, the sealing beads 42, 44 in this embodiment are shown to have a semi-circular shape, each including a crest 46, 48, respectively. The crest 46 of the first sealing bead 42 is laterally offset from the planar body 32. The lateral offset is measured in the direction of the axis D. Likewise, the crest 48 of the second sealing bead 44 is laterally offset from the second planar body 36. In the preferred embodiment, the first sealing bead 42 is laterally offset from the first layer 28 in a direction opposite to that of the second sealing bead 44, and more particularly the two sealing beads 42, 44 are arranged so that their respective crests 46, 48 touch one another in the space between the layers 28, 30, as shown in FIGS. 3, 4C and 5.

In FIGS. 3-5, the first layer 28 is shown including a first rim 50 directly adjacent to and surrounding the first opening 34. The first rim 50 extends laterally, i.e., in the direction of axis D, from the planar body 32 a distance C corresponding to a first rim height measured laterally along the first opening 34. It should be understood, however, that the first rim 50 is not necessarily formed in a perpendicular relationship to the planar body 32. In other words, the extent of the first rim 50 could be angled from the planar body 32 while still having a component of extension in the lateral direction. The first rim height C is shown in FIGS. 4A-C. The second layer 30 includes a second rim 52 directly adjacent to and surrounding the second opening 38. The second rim 52 extends laterally from the planar body 36 of the second layer 30 a distance B corresponding to a second rim height as measured laterally along the second opening 38. Like the first rim 50, the second rim 52 could also be angled from the planar body 32. And still further, it is not required that the first 50 and second 52 rims be parallel to each other, although this is the case in illustrated embodiments. The second rim height B is illustrated in FIGS. 4A and 5.

As shown in the drawings, the dimensions of the first rim 50 are larger than the dimensions of the second rim 52 so that when brought together into an assembled gasket 40, as shown in FIGS. 3, 4C and 5, the first rim 50 will closely surround the second rim 52 in a nested relationship to form a labyrinth stopper. More particularly, the dimensional relationships between the rims 50, 52 and the first layer thickness A are such that the first rim height C is substantially equal to the second rim height B plus the planar body thickness A of the first layer 28. This relationship (C=A+B) is shown quite clearly in FIGS. 4A and 5. As a result, the combination of rims 50, 52 arranged in this fashion form a stopper for the gasket assembly 40. A stopper, as will be readily apparent to those of skill in the art, is commonly used in gasket applications, including cylinder head gaskets but other applications as well, to take up a clamping load so that the sealing beads 42, 44 are not over-compressed and remain spring-like to react under normal operating conditions. In this invention, the rims 50, 52 acting together create a labyrinth design which makes it more difficult for gases to escape even if the layers 28, 30 shift laterally under fluctuating pressures and vibrations in use.

As perhaps best shown in FIGS. 6 and 7, the labyrinth feature can be particularly advantageous in applications where two side-by-side openings are formed in the gasket assembly 40, such as when sealing a multi-cylinder engine cylinder head, or when sealing multiple ports in a manifold which are arranged closely together. In these situations, the narrow region of gasket material between adjacent openings, known generally as the bridge portion, is sometimes difficult to seal particularly in view of the fact that the pressure differential between the adjacent openings may be quite substantial and fluctuate rapidly. FIG. 7 shows, by way of broken line arrows, the tortuous path created by the labyrinth design of this invention through which combustion gases, in this particular example, are forced to navigate when migrating between the layers 28, 30 in the gasket assembly 40. It will be evident that the labyrinth design of the stopper portion of the subject gasket assembly 40 is particularly effective at improving combustion gas sealing, or for other sealed high pressure or low pressure fluids and gases. The labyrinth design is effective because it creates a drastic pressure drop as high pressure gases, sometimes also at high temperatures, try to flow through the labyrinth. Designs of this nature can be expected to function much better at lower clamp loads. Furthermore, the design and construction of the subject gasket assembly 40 presents major commercial advantages in that it can be manufactured at a relatively lower cost than, for example, laser welded stopper gaskets and with lower tooling costs than most prior art designs.

Accordingly, the labyrinth stopper design of this invention, established by the nested, overlapping rims 50, 52, presents a difficult path for combustion gas or other fluids to leak around. The designs illustrated in FIGS. 3-7 represent but one exemplary embodiment. Those of skill in the art will readily appreciate alternative design opportunities, for examples the ones illustrated in FIGS. 8-13.

In the example of FIG. 8, the gasket assembly 40 is shown including a shim layer 54. Of course, multiple shims and even additional functional layers (not shown) may be included using principles known in the art. FIG. 9 illustrates another variation of the subject gasket assembly 40 including a supplemental member 56 attached to the second functional layer 30 between the second sealing bead 44 and the second rim 52. The supplemental member 56 can be either incompressible and cooperate in the stopper function, or alternatively compressible and serve to further enhance the sealing capabilities of the gasket assembly 40. For example, the supplemental member 56 may be used as a backstop to the labyrinth design created by the first 50 and second 52 rims to further impede fluid leakage in operation. The supplemental member 56 can be fabricated from any suitable materials, including metallic and non-metallic compositions. FIG. 10 shows a still further alternative design, similar to that of FIG. 9, but wherein the supplemental member 56 is associated with the first layer 28 rather than the second layer 30.

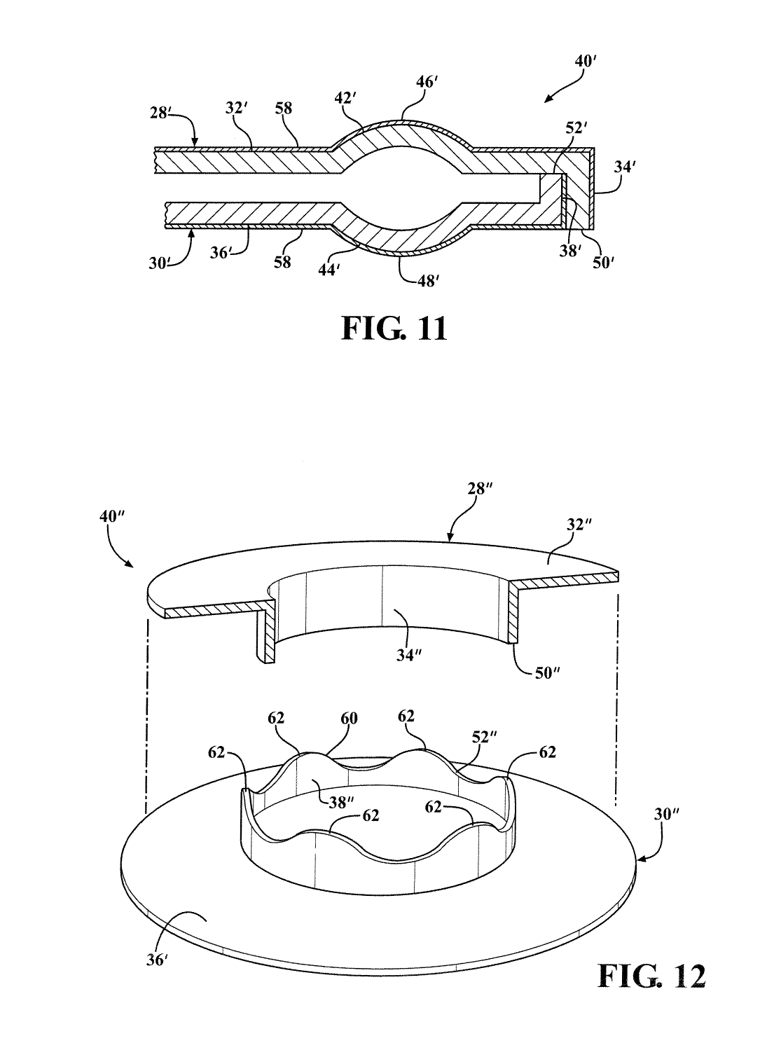

FIG. 11 illustrates a first alternative embodiment of the subject invention, wherein reference numerals are used with prime designations to illustrate like or corresponding parts to the preceding embodiments. In this example, the sealing beads 42′, 44′ extend outwardly from one another so that their respective crests 46′, 48′ do not touch one another even when compressed between mating surfaces. Also in this example, the first layer 28′ is shown arranged on the top side of the gasket assembly 40′ with the second layer 30′ forming a bottom surface of the gasket assembly 40′. Also shown in this example is an optional elastomer coating 58 which may be applied to the gasket consistent with known techniques, such as described more fully in the previously mentioned US Publication No. 2005/0189724. The optional coating 58 can be applied to one or both sides of either or both of the first 28′ and second 30′ layers.

Of course, the various alternative configurations shown throughout all of the figures can be used almost interchangeably to create a wide variety of gasket constructions still within the scope of the invention. It should be noted that the relationship between first C and second B rim heights can also be altered so that the equation A+B=C does not necessarily apply. For example, either of the first or second rim heights C, B can be extended slightly so that that particular rim 50, 52 functions alone as the stopper feature instead of both rims 50, 52 acting in concert. For example, if the second rim height B is shortened, it will not make contact with the planar body 32 of the first functional layer when the gasket assembly 40 is fully compressed in use. In this example, the first rim 50 alone serves as the stopper feature for the gasket, perhaps in combination with a supplemental member 56 as shown in FIGS. 9 and 10. Alternatively, if the first rim height C is shortened slightly, then the second rim 52 will contact the first planar body 32 when compressed and alone serve as a stopper feature, possibly in combination with a supplemental member 56. Thus, while in the preferred embodiment both rims 50, 52 cooperate together to form a stopper, either can act alone in some contemplated embodiments of this invention.

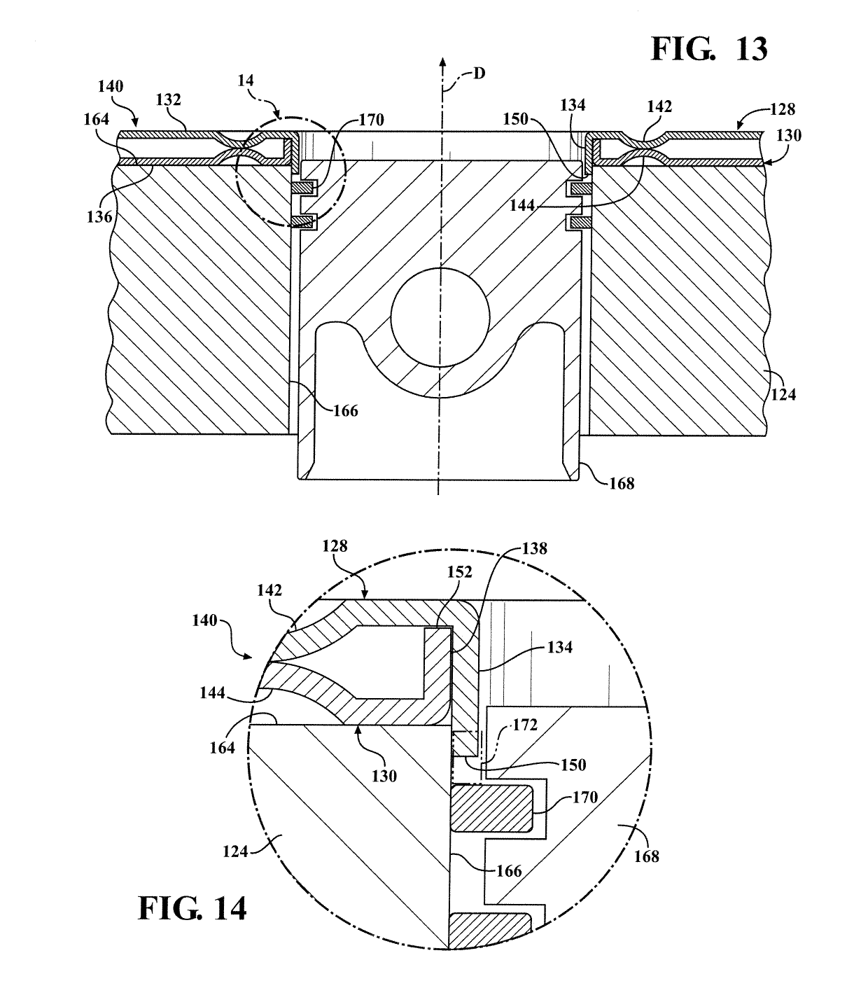

Furthermore, as shown in FIG. 12, a second rim 52″ can be formed with an undulating profile 60 with its alternating peaks 62 establishing the second rim height. In this example reference numerals corresponding to parts in preceding embodiments are signified with double-prime designations. The undulating profile 60 is shown having a generally sinusoidal configuration in FIGS. 12 and 13 which is highly exaggerated for clarity. Of course, a similar construction may be established by creating an undulating profile on the first rim 52″.

The labyrinth design of the subject invention is created by folding the two functional layers 28, 30 in opposing directions to create respective rims 50, 52 as shown in the figures. When assembled, the rims 50, 52 mesh within each other and serve as a combined stopper and labyrinth barrier to the leakage of fluids. When compressed, the thickness of the rims 50, 52, or of at least one rim acting alone, will take up the clamping load as well as present a leading seal interface to the fluids, which may comprise combustion gases through the labyrinth. As a result, a particular advantage of this concept relates to its ability to provide sealing even when the clamped members, for example a cylinder head and block, lift significantly in operation.

A second alternative embodiment of the subject invention is illustrated in FIGS. 13-17, where like reference numerals offset by 100 are used to indicate like or corresponding features. In FIG. 13, the second alternative embodiment of the gasket assembly 140 is shown disposed for operation in the exemplary application of the cylinder head gasket placed for operation upon a cylinder block 124 and aligned over the combustion chamber opening as described above. The cylinder block 124 is shown here including a top deck surface 164. The combustion chamber formed in the block 124 is defined by a cylindrical side wall 166. This side wall 166 could be part of a cylinder liner in some engine designs. A piston 168 is of the common type disposed in the combustion chamber for reciprocating movement toward and away from a top dead center position which is illustrated in highly simplified form in FIG. 13. As is typical with most internal combustion engines, the piston 168 includes one or more piston rings which directly engage the side wall 166 of the combustion chamber. One or more piston rings are carried in ring grooves formed near the top or crown of the piston 168. The top piston ring is indicated at 170 in FIGS. 13 and 14.

As perhaps best shown in the enlarged FIG. 14, most piston engines possess a crevice volume 172 defined in the space between the piston 168 and the side wall 166, above the top piston ring 170. In other words, the annular region below the deck surface 164 inside the combustion chamber and above the top ring 170 when the piston is in its top dead center position is considered the crevice volume 172 which can be a particularly difficult area to manage. In some piston designs, this area can resist the combustion event, resulting in unburdened fuel which contributes to reduced economy and increased emissions. Additionally, the crevice volume 172 can accumulate carbon deposits and other undesirable residues which can lead to problems such as auto-ignition, valve damage, overheating and other effects. Therefore, the ability to substantially reduce the crevice volume 172 will be met with considerable interest and acceptance within the industry.

According to this second alternative embodiment of the gasket assembly 140, the first rim 150 has an extended length so that it hangs down below the planar body 136 of the second layer 130 as well as below the top deck 164, thus partially or nearly completely filling the crevice volume 172. With reference to the dimensional relationships described above in connection with FIGS. 4A-5, according to this second alternative embodiment the first rim height C is greater than the sum of the second rim height B plus the planar body thickness A of the first layer 128. See FIG. 16. This extension of the first rim 150 allows the gasket assembly 140 to be more responsive to dynamic engine motion.

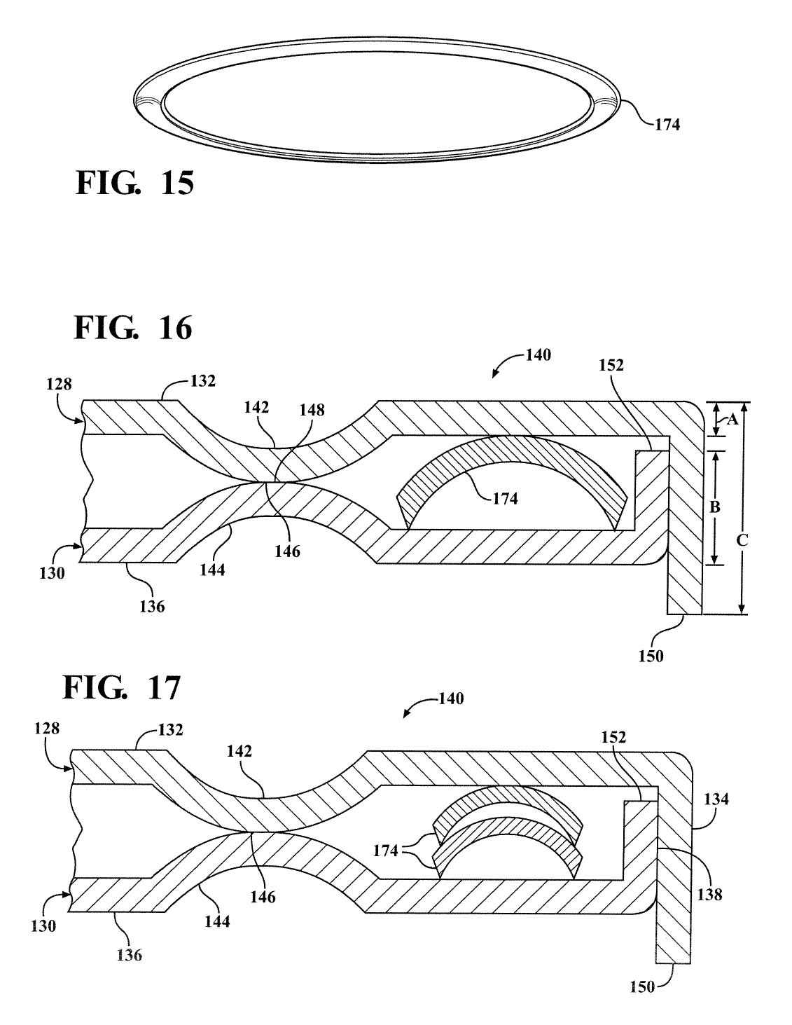

FIGS. 15-17 describe an optional feature that may be incorporated into any of the embodiments described above. In particular, the invention may include a spring element 174 shown here in the form of an annular member having a generally U-shaped cross-section. The spring element 174 may be disposed between the first 124 and second 130 layers at a location near the respective first 134 and second 138 openings. The cross-section may substantially fill the interstitial space as shown in FIG. 16, or allow for two or more spring elements 174 to be stacked for increased resistance. The spring element 164 may be made from any suitable material including spring steel and other engineered materials such as those commonly used in metal layer gasket constructions.

Because engine dynamic motion is increasing with new high performance engine designs, it is becoming evident that conventional gaskets may be approaching their operating limits. The second alternative embodiment as shown in FIGS. 13-17 represents a radial sealing concept where the potential leak path for combustion gas is blocked by the first rim 150 which is bent 90 degrees from the planar body 32 and extends past the block deck surface 164 into the small crevice volume 172 created by the block 124/liner 166 surface, piston 168 and top piston ring 170. A spring element 174 can optionally be included to provide improved dynamic response. A design of this nature will potentially offer the benefit of minimal head/block 124 damage as the layers of the gasket assembly 40 will act as protection layers and even more so if the spring element 174 is included. As can be seen in the figures, there are several notable components of the gasket design. These include a radial seal which provides a first barrier to combustion gas leakage. Radial seals of this nature are generally less sensitive to load variations due to head 22 lift, because the sealing direction is different from the head 22 lift direction. The labyrinth configuration, as described above, provides a second line of defense against combustion gas leakages. The labyrinth configuration is effective to help quickly reduce pressure for gas leakage. The spring element 174 may be sandwiched between the two layers 128, 130 for the purpose of helping to maintain good sealing contact as the engine fires.

The foregoing invention has been described in accordance with the relevant legal standards, thus the description is exemplary rather than limiting in nature. Variations and modifications to the disclosed embodiment may become apparent to those skilled in the art and fall within the scope of the invention. For example, one or both sealing beads could be located on different layers from the labyrinth stopper features. As an example, the sealing beads might be formed as parts of two intermediate layers. Many other variations are also certainly possible and within the spirit and scope of this invention.

What is claimed is:

1. A multi-layered gasket assembly (140) of the type for sealing around a passage or chamber, said gasket assembly (140) comprising:
a first functional layer (128) comprising a generally planar body (132) having a thickness (A); said first layer (128) having an included first opening (134);
a second functional layer (130) comprising a generally planar body (136) having a thickness, said second layer (130) having an included second opening (138);
said first layer (128) overlying said second layer (130) such that said respective first (134) and second (138) openings are generally aligned along a respective laterally extending axis (D);
said first layer (128) including a first rim (150) directly adjacent said first opening (134); said first rim (150) extending laterally downwardly from said planar body (132) of said first layer (128) to a first terminal edge; said first rim (150) having a first rim height (C) measured axially at said first opening (134);
said second layer (130) including a second rim (152) directly adjacent said second opening (138); said second rim (152) extending laterally upwardly from said planar body (136) of said second layer (130) to a second terminal edge; said second rim (150) having a second rim height (B) measured axially at said second opening (138);
said first rim (150) closely surrounding said second rim (152) in nested overlapping relationship to form a labyrinth about said opening (134, 138);
said first rim height (C) being greater than the sum of said second rim height (B) plus said thickness (A) of said first layer (128) such that said first terminal edge extends below said planar body (136) of said second layer (130).

2. The gasket assembly (140) of claim 1, wherein said second terminal edge of said second rim (152) has an undulating profile (160).

3. The gasket assembly (140) of claim 1, wherein said first layer (128) includes an integrally formed first sealing bead (142) spaced apart from said first opening (134); and said second layer (130) includes an integrally formed second sealing bead (144) spaced apart from said second opening (138).

4. The gasket assembly (140) of claim 3, wherein said first sealing bead (142) includes a crest (146) laterally offset from said planar body (132) of said first layer (128); and
said second sealing bead (144) includes a crest (148) laterally offset from said planar body (136) of said second layer (130).

5. The gasket assembly (140) of claim 4, wherein said first sealing bead (142) is laterally offset from said first layer (128) in a direction opposite to the lateral offset of said second sealing bead (144) relative to said second layer (130).

6. The gasket assembly (140) of claim 5, wherein said crests (146, 148) of said respective first (142) and second (144) sealing beads are in direct touching contact with one another.

7. The gasket assembly (140) of claim 1, further including a supplemental member (56) disposed between said first (128) and second (130) layers.

8. The gasket assembly (140) of claim 1, wherein said first (128) and second (130) layers are fabricated from a metallic material.

9. The gasket assembly (140) of claim 1, wherein at least one of said first (128) and second (130) layers includes an elastomer coating (158) covering one side thereof.

10. The gasket assembly (140) of claim 1, wherein at least one intermediate layer (54) is disposed between said first (128) and second (130) layers.

11. The engine of claim 1, further including at least one spring element (174) disposed between said first (128) and second (130) layers.

12. The engine of claim 1, wherein said spring element (174) comprises an annual member having a generally U-shaped cross-section.

13. The engine of claim 1, further including at least two spring elements (174) disposed between said first (128) and second (130) layers, said spring elements (174) each comprising an annual member having a generally U-shaped cross-section.

14. The engine of claim 13, wherein said at least two spring elements (174) are disposed in a nested relationship with one another.

15. A multi-layered gasket assembly (140) of the type for sealing around a passage or chamber, said gasket assembly (140) comprising:
a first functional layer (128) comprising a generally planar body (132) having a generally uniform thickness (A); said first layer (128) fabricated from a metallic material, said first layer (128) having at least one fully included first opening (134);
a second functional layer (130) in direct contact with said deck of said block, said second layer (130) comprising a generally planar body (136) having a generally uniform thickness, said second layer (130) fabricated from a metallic material, said second layer (130) having at least one included second opening (138);
said first layer (128) overlying said second layer (130) such that said respective first (134) and second (138) openings are generally aligned along a respective laterally extending axis (D);
said first layer (128) including a first sealing bead (142) spaced apart from and surrounding said first opening (134); said first sealing bead (142) including a crest (146) laterally offset from said planar body (132) of said first layer (128);
said second layer (130) including a second sealing bead (144) spaced apart from and surrounding said second opening (138); said second sealing bead (144) including a crest (148) laterally offset from said planar body (136) of said second layer (130);
said first sealing bead (142) being laterally offset from said first layer (128) in a direction opposite to the lateral offset of said second sealing bead (144) relative to said second layer (130);
said first layer (128) including a first rim (150) directly adjacent said first opening (134); said first rim (150) extending laterally from said planar body (132) of said first layer (128) to a first terminal edge; said first rim (150) having a first rim height (C) measured axially at said first opening (134);
said second layer (130) including a second rim (152) directly adjacent said second opening (138); said second rim (152) extending laterally from said planar body (136) of said second layer (130) to a second terminal edge; said second rim (150) having a second rim height (B) measured axially at said second opening (138);
said first rim (150) closely surrounding said second rim (152) in nested overlapping relationship to form a labyrinth about said opening (134, 138);
said first rim height (C) being greater than the sum of said second rim height (B) plus said planar body thickness (A) of said first layer (128) such that said first terminal edge extends below said planar body (136) of said second layer (130).

16. An internal combustion engine comprising:
a block (124) having a top deck surface (164), at least one combustion chamber formed in said block (124), said combustion chamber defined by a cylindrical side wall (166);
a piston (168) disposed in said combustion chamber for reciprocating movement toward and away from a top dead center position, said piston (168) including a top piston ring (170) extending radially outwardly therefrom and directly engaging said side wall (166) of said combustion chamber, a crevice volume defined in the space between said piston (168) and said side wall (166) above said top piston ring (170) and below said deck surface (164);
multi-layered cylinder head gasket assembly (140) of the type for sealing around said combustion chamber, said gasket assembly (140) comprising:
a first functional layer (128) comprising a generally planar body (132) having a generally uniform thickness (A); said first layer (128) fabricated from a metallic material, said first layer (128) having at least one fully included first opening (134) for sealing around said combustion chamber;
a second functional layer (130) in direct contact with said deck of said block, said second layer (130) comprising a generally planar body (136) having a generally uniform thickness, said second layer (130) fabricated from a metallic material, said second layer (130) having at least one included second opening (138) for sealing around said combustion chamber;
said first layer (128) overlying said second layer (130) such that said respective first (134) and second (138) openings are generally aligned along a respective laterally extending axes (D);
said first layer (128) including a first sealing bead (142) spaced apart from and surrounding said first opening (134); said first sealing bead (142) including a crest (146) laterally offset from said planar body (132) of said first layer (128);
said second layer (130) including a second sealing bead (144) spaced apart from and surrounding said second opening (138); said second sealing bead (144) including a crest (148) laterally offset from said planar body (136) of said second layer (130);
said first sealing bead (142) being laterally offset from said first layer (128) in a direction opposite to the lateral offset of said second sealing bead (144) relative to said second layer (130);
said first layer (128) including a first rim (150) directly adjacent said first opening (134); said first rim (150) extending laterally from said planar body (132) of said first layer (128) to a first terminal edge; said first rim (150) having a first rim height (C) measured axially at said first opening (134);
said second layer (130) including a second rim (152) directly adjacent said second opening (138); said second rim (152) extending laterally from said planar body (136) of said second layer (130) to a second terminal edge; said second rim (150) having a second rim height (B) measured axially at said second opening (138);
said first rim (150) closely surrounding said second rim (152) in nested overlapping relationship to form a labyrinth about said opening (134, 138) and about said combustion chamber;
said first rim height (C) being greater than the sum of said second rim height (B) plus said planar body thickness (A) of said first layer (128) such that said first terminal edge extends into said crevice volume.

17. The engine of claim 16, further including at least one spring element (174) disposed between said first (128) and second (130) layers.

18. The engine of claim 16, wherein said spring element (174) comprises an annual member having a generally U-shaped cross-section.

19. The engine of claim 16, further including at least two spring elements (174) disposed between said first (128) and second (130) layers, said spring elements (174) each comprising an annual member having a generally U-shaped cross-section.

20. The engine of claim 19, wherein said at least two spring elements (174) are disposed in a nested relationship with one another.
